(19) United States
(12) Patent Application Publication
(10) Pub. No.: US 2012/0099289 A1
(43) Pub. Date: Apr. 26, 2012

(54) LIGHT-EMITTING APPARATUS AND METHOD OF USE THEREOF

(75) Inventors: Jyun-Sheng SYU, Taipei Hsien (TW); Shih-Yu WANG, Taipei Hsien (TW); Cheng-Hua TIEN, Taipei Hsien (TW)

(73) Assignee: Wistron Corporation, Taipei Hsien (TW)

(21) Appl. No.: 13/280,453

(22) Filed: Oct. 25, 2011

(30) Foreign Application Priority Data
Oct. 26, 2010 (TW) 099220686

(51) Int. Cl. F21V 9/16

(52) U.S. Cl. 362/84

(57) ABSTRACT

A light-emitting apparatus and a method of use thereof are disclosed. The light-emitting apparatus includes a light-emitting module for emitting an original light, a color filter including a first and a second area, and first and second fluorescent powders. The color filter is positioned outside the light-emitting module to allow the original light to penetrate it. The color filter can move relative to the light-emitting apparatus, such that the original light can selectively penetrate the first or second area. The first and second fluorescent powders are respectively positioned in the first and second areas. When the first area moves to the outside of the light-emitting apparatus, the original light penetrates the first fluorescent powder and is transformed into a first emitted light, and the same occurs for the second area and the second fluorescent powder.

### BACKGROUND OF THE INVENTION

1. Field of the Invention

The present invention relates to a light-emitting apparatus and a method of use thereof, especially to a light-emitting apparatus capable of producing lights having different color temperatures or color rendering and a method of use thereof.

2. Description of the Related Art

The use of light-emitting diodes (LEDs) components in the field of illumination has been considerably increasing recently. For example, LEDs are extensively applied to mobile phones, televisions, and other electronic products.

For some conventional white light LEDs, the red light LED chip, the green light LED chip, and the blue light LED chip are packaged together in the same element package structure. The emissions of the three kinds of chips are mixed to produce white light. However, since the production cost of such an approach is very high, there is little economic benefit when the approach is applied to a general lighting device (such as a fluorescent tube). The luminescence characteristics of the light emitted by conventional LEDs components are determined when the light-emitting diodes are packaged and cannot be changed after packaging. According to research, humans have different emotional responses to different color temperatures or color rendering. The only way to adjust color temperature and or rendering is by change the ratio of mixing R, G, B LEDs. But it's costly.

Therefore, it is advantageous to provide a light-emitting apparatus and a method of use thereof to mitigate and/or obviate the aforementioned problem that the luminescence characteristics of the LEDs components cannot be dynamically changed.

### SUMMARY OF THE INVENTION

It is a main object of the present invention to provide a light-emitting apparatus and a method of use thereof to mitigate and/or obviate the aforementioned problems.

A light-emitting apparatus of the present invention comprises a light-emitting module, a color filter, a first fluorescent powder, and a second fluorescent powder. The light-emitting module is for emitting an original light. The color filter is positioned outside the light-emitting module to allow the original light to penetrate the color filter. The color filter comprises a first area and a second area. The color filter is able to move relative to the light-emitting module such that the original light is able to selectively penetrate by the first area or the second area. The first fluorescent powder is positioned in the first area. When the first area moves above the light-emitting module, the original light penetrates the first fluorescent powder and is transformed into a first emitted light. The second fluorescent powder is positioned in the second area. When the second area moves above the light-emitting module, the original light penetrates the second fluorescent powder and is transformed into a second emitted light. The first emitted light and the second emitted light have different color temperatures or color rendering.

In one embodiment of the present invention, the light-emitting module comprises at least one LED chip and a substrate. The at least one LED chip is positioned on the substrate. In one embodiment of the present invention, the LED chip is a blue light LED chip.

By the present invention, the method of using the light-emitting apparatus comprises the following steps: making the light-emitting module emits the original light; and moving the color filter.

### BRIEF DESCRIPTION OF THE DRAWINGS

FIG. 1 illustrates a cross-sectional drawing of an embodiment of a light-emitting apparatus of the present invention, and a first area is positioned above a light-emitting module.

FIG. 2 illustrates a cross-sectional drawing of an embodiment of the light-emitting apparatus of the present invention, and a second area is positioned above the light-emitting module.

FIG. 3 illustrates a schematic drawing of first fluorescent powder of the light-emitting apparatus of the present invention applied to the first area.

FIG. 4 illustrates a schematic drawing of first fluorescent powder of the light-emitting apparatus of the present invention doped in the first area.

FIG. 5 illustrates a spectrogram of an embodiment of a first emitted light of the light-emitting apparatus of the present invention.

FIG. 6 illustrates a spectrogram of an embodiment of a second emitted light of the light-emitting apparatus of the present invention.

FIG. 7 illustrates a schematic exploded view of an embodiment of the light-emitting apparatus of the present invention.

FIG. 8 illustrates a schematic assembly drawing of an embodiment of the light-emitting apparatus of the present invention.

FIG. 9 illustrates a flowchart of an embodiment of a method of using the light-emitting apparatus of the present invention.

FIG. 10 illustrates a schematic drawing of another embodiment of the light-emitting apparatus of the present invention.

### DETAILED DESCRIPTION OF THE PREFERRED EMBODIMENT

The advantages and innovative features of the invention will become more apparent from the following detailed description when taken in conjunction with the accompanying drawings.

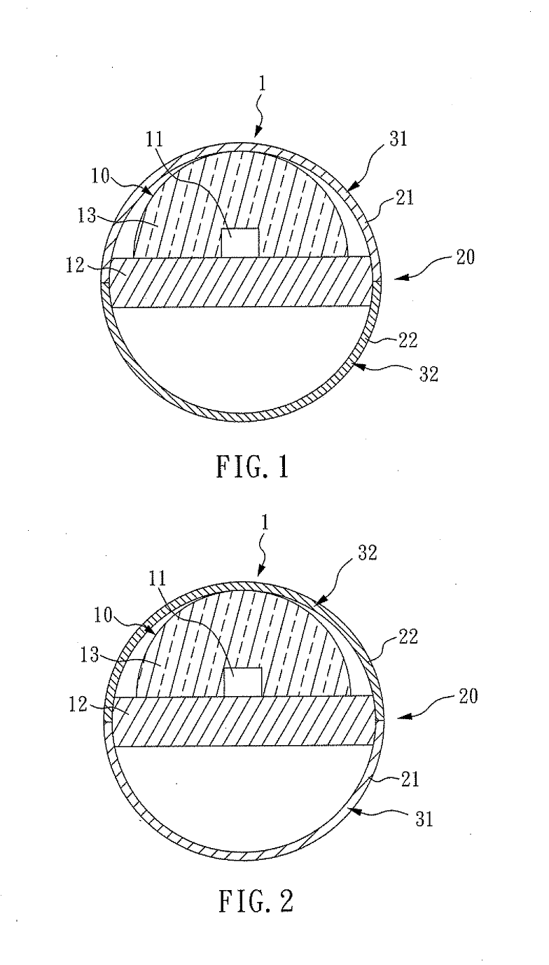

Please refer to FIG. 1 to FIG. 8 for the following paragraphs regarding an embodiment of a light-emitting apparatus of the present invention.

As shown in FIG. 1, the light-emitting apparatus 1 of the present invention comprises a light-emitting module 10, a color filter 20, a first fluorescent powder 31, and s second fluorescent powder 32.

The light-emitting module 10 is for emitting an original ray of. light. In one embodiment of the present invention, the light-emitting module 10 comprises a LED chip 11, a substrate 12, and a package 13. The LED chip 11 is positioned on the substrate 12. The package 13 covers the LED chip 11. The package 13 of the present invention is for protecting the LED chip 11. Moreover, the package 13 is able to improve the light illumination efficiency of the LED chip 11 and reduce the influence of total reflection. The material of the package 13 of the present invention may be glass or silica gel. However, the present invention is not limited to the above materials. It should be noted that the package 13 is not a necessary component of the present invention. The substrate 12 of the present invention may be a printed circuit board (PCB) or a Metal Core PCB (MCPCB). However, the present invention is not limited to these types.

The LED chip 11 of an embodiment of the present invention is mounted on the substrate 12 by the use of Surface Mount Technology (SMT). However, the present invention is not limited to this method of mounting. In one embodiment of the present invention, the LED chip 11 is a blue light LED chip. However, the present invention is not limited to a blue light LED chip.

The color filter 20 of the present invention is positioned outside the light-emitting module 10. The color filter 20 comprises a first area 21 and a second area 22. Moreover, the color filter 20 is able to move relative to the light-emitting module 10 such that the original ray of light is able to selectively penetrate through the first area 21 or the second area 22. In one embodiment of the present invention, the material of the color filter 20 may be glass or silica gel. However, the present invention is not limited to the above materials.

As shown in FIG. 1, in one embodiment of the present invention, the first fluorescent powder 31 is positioned in the first area 21. When the first area 21 moves above the light-emitting module 10, the original ray of light penetrates the first fluorescent powder 31 and is transformed into a first emitted ray of light. As shown in FIG. 2, the second fluorescent powder 32 is positioned in the second area 22. When the second area 22 moves to above the light-emitting module 10, the original ray of light penetrates the second fluorescent powder 32 and is transformed into a second emitted ray of light. It should be noted that when the first area 21 and the second area 22 are simultaneously above the light-emitting module 10, the original ray of light is able to penetrate the first fluorescent powder 31 and the second fluorescent powder 32 simultaneously and be transformed into a mixed light composed of both the first emitted light and the second emitted light. It should be noted that the color filter 20 of the present invention is not limited to having only the first area 21 and the second area 22. The color filter 20 can further comprise a third area (or additional areas), and a third (or additional) fluorescent powder may be positioned in the third area (or additional areas).

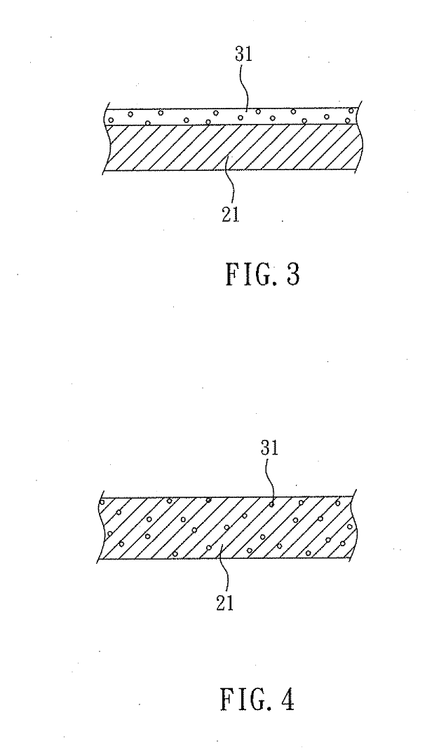

In one embodiment of the present invention, the first fluorescent powder is yellow fluorescent powder, and the second fluorescent powder comprises red fluorescent powder and green fluorescent powder. However, the present invention is not limited to powders of these colors. In one embodiment of the present invention, the first fluorescent powder 31 is applied to an outer surface (as shown in FIG. 3) or an inner surface (not shown) of the first area, and the second fluorescent powder is applied to an outer surface or an inner surface (not shown) of the second area, though the present invention is not limited to these locations. In another embodiment of the present invention, the first fluorescent powder 31 and the second fluorescent powder 32 are respectively doped in the first area 21 (as shown in FIG. 4) and the second area (not shown). Because the manners of applying powder to or doping powder into glass or silica gel are well known to those of reasonable skill in the art, the detailed descriptions of methods for doing so are omitted.

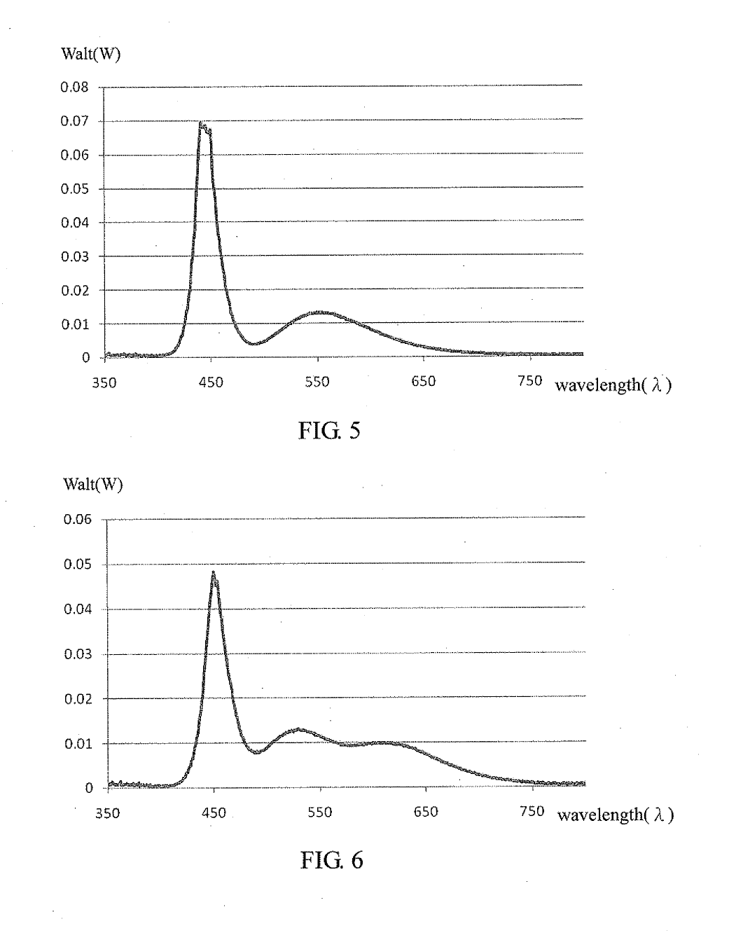

In one embodiment of the present invention, when the first area 21 moves above the light-emitting module 10, the original light penetrates the first fluorescent powder 31 and is transformed into a first emitted light. Its spectrogram is shown in FIG. 5. In one embodiment of the present invention, when the second area 22 moves above the light-emitting module 10, the original light penetrates the second fluorescent powder 32 and is transformed into a second emitted light. Its spectrogram is shown in FIG. 6. In one embodiment of the present invention, the original light emitted by the blue light LED chip is blue light. The first emitted light transformed by the original light penetrating the first fluorescent powder (i.e., yellow fluorescent powder) is white light. The second emitted light transformed by the original light penetrating the second fluorescent powder (i.e., red fluorescent powder mixed with green fluorescent powder) is white light, too. As can be seen in FIG. 5 and FIG. 6, however, the color rendering of the second emitted light is better than the color rendering of the first emitted of light. With the above design, the light-emitting apparatus 1 of the present invention is able to provide emitted light with different color temperatures or color rendering even though the light-emitting module 10 produces original light of only a single color.

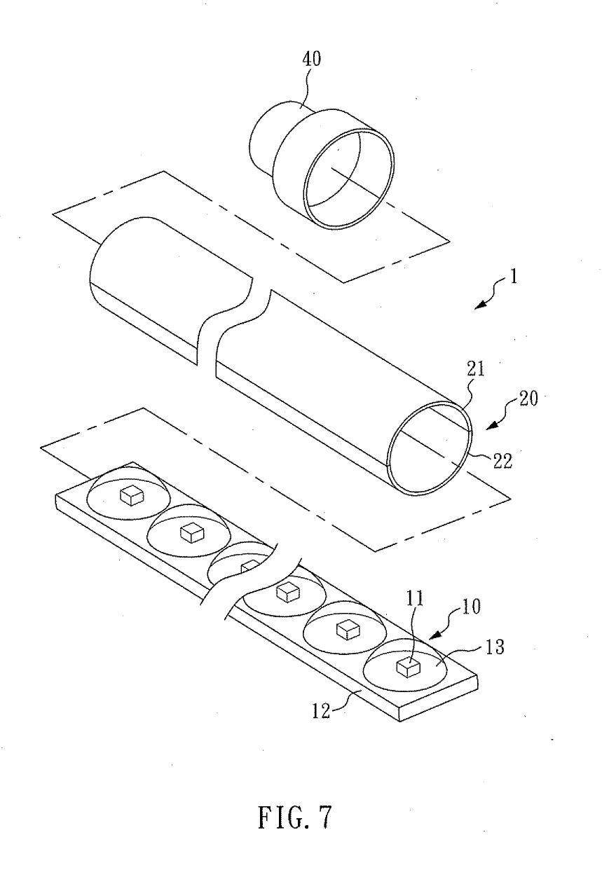

As shown in FIG. 7, in one embodiment of the present invention, the light-emitting module 10 is an LED light bar. A plurality of LED chips 11 are positioned on the substrate 12. Each package 13 covers each LED chip 11. In one embodiment of the present invention, the color filter 20 is substantially cylindrical. The light-emitting module 10 is positioned inside the color filter 20. The shape of the color filter 20 of the present invention, however, is not limited to a cylinder. For example, the color filter 20 may also be formed of a triangular prism or a rectangular prism (not shown). In one embodiment of the present invention, the light-emitting apparatus 1 further comprises a driving unit 40. The driving unit 40 connects with the color filter 20 to make the color filter 20 to move relative to the light-emitting module 10. It should be noted that the light-emitting apparatus of the present invention can also comprise a plurality of light-emitting modules. The light-emitting modules can be connected and arranged to allow different light-emitting modules emit lights having, different color temperatures or color rendering to penetrate each area of the color filter.

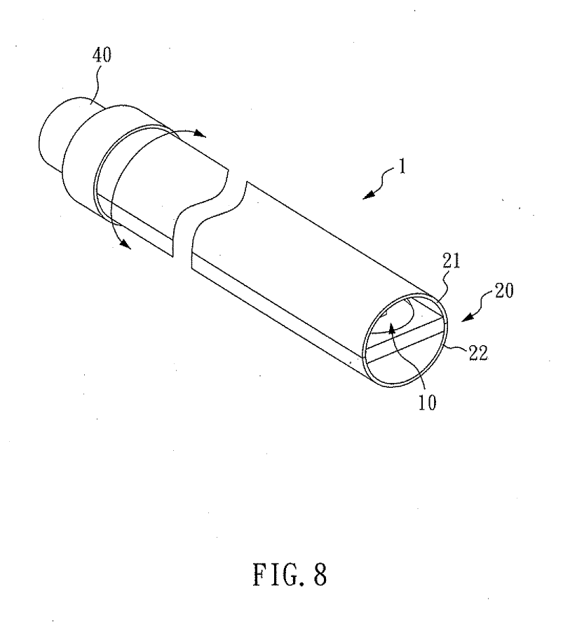

As shown in FIG. 8, the color filter 20 is rotated by the driving unit 40 to allow the first area 21 or the second area 22 to be positioned above the light-emitting module 10, such that the original light is able to selectively penetrate the first area 21 or the second area 22 to produce the first emitted light or the second emitted light.

The following paragraphs illustrate each step of a method of use of the light-emitting apparatus of the present invention by using the light-emitting apparatus 1 of the present invention shown in FIG. 1 and FIG. 8 as an example.

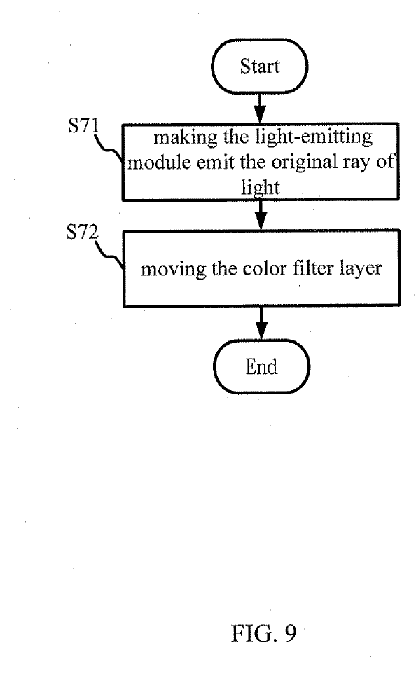

As shown in FIG. 9, the present invention performs step S71 first: making the light-emitting module emit the original light.

In one embodiment of the present invention, the original light is blue light. The details of the light-emitting module 10 are illustrated in the above paragraphs, and so they are not elaborated upon.

Step S72 is performed next: moving the color filter.

In one embodiment of the present invention, the color filter 20 can be moved by the driving unit 40 of the present invention, such that the color filter 20 moves relative to the light-emitting module 10, such that the first area 21 or the second area 22 is positioned above the light-emitting module 10. The original light can penetrate the first area 21 or the second area 22 to produce the first emitted light or the second emitted light. The details of the original light being able to penetrate the first area 21 or the second area 22 such that the first emitted light or the second emitted light is produced are described above, and so they not elaborated upon, It should be noted that the movement of the color filter 20 also can allow part of the first area 21 and part of the second area 22 to be simultaneously positioned above the light-emitting module 10 (not shown). The original light is able to penetrate the first area 21 and the second area 22 to produce a mixed light composed of both the first emitted light and the second emitted light. With this design, a user can move the color filter 20 to switch between the first emitted light and the second emitted light.

The light-emitting apparatus of the present invention brings the following benefits: 1. The lights emitted by the light-emitting apparatus can have different color temperatures or color rendering by changing the constituents of the fluorescent powder and the position of the color filter. 2. The light-emitting apparatus of the present invention can be applied to many products, such as a backlight module or general lamps and lanterns (such as fluorescent tubes). 3. The production costs are reduced. The LED chip 11 of the light-emitting apparatus of the present invention can be mounted on the substrate 12 by the use of SMT so as to reduce production costs. Moreover, this can improve the design of the heat dissipation of the LED chip considerably so as to prevent the light illumination efficiency of the LED chip from being reduced due to heat effects. 4. The influence of heat effects of the chip on the fluorescent powder is prevented. Applying fluorescent powder based on the concept of Remote Phosphor can effectively prevent the fluorescent powder from being influenced by the heat effects of the chip. Therefore, the package structure of the present invention can maintain the light illumination efficiency of the light source of the LED chip well so as to prevent the conversion efficiency of the fluorescent powder from being decreased.

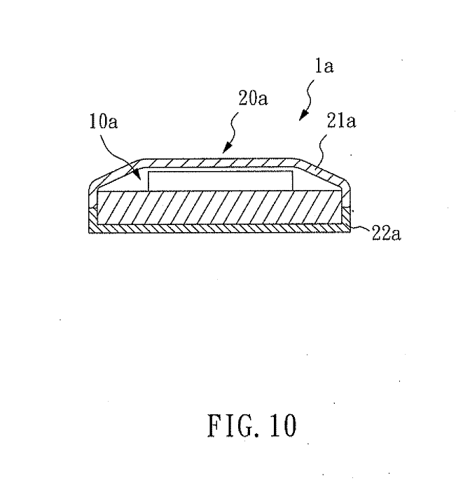

As shown in FIG. 10, in another embodiment of the present invention, a color filter 20a of a light-emitting apparatus 1a is in the form of a movable caterpillar band. The material of the color filter 20a is silica gel, whereby the color filter 20a is able to move along a light-emitting module 10a and change its shape corresponding to the shape of the light-emitting module 10a, such that the original light is able to selectively penetrate a first area 21a or a second area 22a to produce the first emitted light or the second emitted light.

It should be noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A light-emitting apparatus, comprising:
a light-emitting module, for emitting an original light;
a color filter positioned outside the light-emitting module to allow the original light to penetrate the color filter, the color filter comprising a first area and a second area and the color filter being able to move relative to the light-emitting module, such that the original light is able to selectively penetrate the first area or the second area;
a first fluorescent powder positioned in the first area, such that when the first area moves above the light-emitting module, the original light penetrates the first fluorescent powder and is transformed into a first emitted light; and
a second fluorescent powder, positioned in the second area, such that when the second area moves above the light-emitting module, the original light penetrates the second fluorescent powder and is transformed into a second emitted light.

2. The light-emitting apparatus as claimed in claim 1, wherein the light-emitting module comprises:
at least one light-emitting diode chip; and
a substrate, wherein the at least one light-emitting diode chip is positioned on the substrate.

3. The light-emitting apparatus as claimed in claim 2, wherein the light-emitting diode chip is a blue light-emitting diode chip.

4. The light-emitting apparatus as claimed in claim 1, wherein the first fluorescent powder is yellow fluorescent powder, and the second fluorescent powder comprises red fluorescent powder and green fluorescent powder, wherein the color rendering of the second emitted light is better than the color rendering of the first emitted light.

5. The light-emitting apparatus as claimed in claim 2, wherein the light-emitting module further comprises a package for covering the light-emitting diode chip.

6. The light-emitting apparatus as claimed in claim 1, wherein the first fluorescent powder is applied to an outer surface or an inner surface of the first area, and the second fluorescent powder is applied to an outer surface or an inner surface of the second area.

7. The light-emitting apparatus as claimed in claim 1, wherein the first fluorescent powder and the second fluorescent powder are respectively doped within the first area and the second area.

8. The light-emitting apparatus as claimed in claim 1, wherein the color filter is substantially cylindrical, and the light-emitting module is positioned inside the color filter.

9. The light-emitting apparatus as claimed in claim 1, wherein the material of the color filter comprises glass or silica gel.

10. The light-emitting apparatus as claimed in claim 1, further comprising a driving unit for allowing the color filter to move relative to the light-emitting module.
